(19) United States
(12) Patent Application Publication
(10) Pub. No.: US 2026/0202266 A1
(43) Pub. Date: Jul. 16, 2026

(54) UNIVERSAL APPARATUS FOR ELECTROTRIBOLOGICAL TESTING OF ROLLING ELEMENTS

(71) Applicants: Michael Vinogradov-Nurenberg, San Jose, CA (US); Vishal Khosla, San Jose, CA (US)

(72) Inventors: Michael Vinogradov-Nurenberg, San Jose, CA (US); Vishal Khosla, San Jose, CA (US)

(21) Appl. No.: 19/021,223

(22) Filed: Jan. 15, 2025

(51) Int. Cl. G01L 1/00; G01N 3/50

(52) U.S. Cl. CPC G01L 1/005; G01N 3/50

(57) ABSTRACT

The apparatus of the present invention is a testing machine for electrotribological testing of roller specimens of various shapes, sizes and materials for testing resistance to wear, scoring, fatigue, pitting, with linear or point contacts in a wide range of test conditions. The apparatus contains a mounting plate that supports two independently driven roller-supporting shafts. At least one of the shafts consists of a first portion, a second portion that can be moved relative to the first shaft in a plane-parallel or angular direction with respect to the first shaft, whereby the test rolling specimens may have a cylindrical, barrel-like, or tapered shape. A system for passing and controlling an electric current between the test specimens is provided for testing the effect of an electric current on endurance of the rolling specimens.

### FIELD OF THE INVENTION

The present invention relates to the field of testing materials, in particular to the field of tribology, and more specifically, to an apparatus for electrotribological testing of rolling specimens under various operation conditions. The rolling specimens of cylindrical, conical, or barrel shapes are tested for resistance to wear, fatigue (pitting), scoring (scuffing) and to the effect on these functional properties of electric currents that pass through the area of rolling contact.

### BACKGROUND OF THE INVENTION AND DESCRIPTION OF THE PRIOR ART

Downsizing (power-to-weight ratio) and higher speeds anticipate a continuous rise in Hertzian contact stresses and oil film (or surface) temperatures. The increase in transmitted power, loads (Hertzian contact stresses) and operating speeds of modern equipment leads to increased wear, fatigue failures and reduced life cycle of moving parts of equipment in operation. Therefore, increasing demands are placed on devices for evaluating the materials of components operating under various tribological conditions including those in which an electric current may pass through the area of rolling contact. A significant part of such tribosystems that operates under rolling or slip-rolling motion are rolling bodies/elements, such as inner and outer rings and rolling elements in bearings, rail-wheel rolling contacts, continuous velocity transmission (CVT) gears, toroidal gears, cam/follower systems, rolling guide rollers of metal-cutting and woodworking machines, transportation vehicles, etc.

In view of the above, increased requirements are also placed on equipment for testing rolling elements to identify factors affecting their durability, taking into account loads, lubricating oils, lubrication regimes, types of materials of interacting parts and their operating conditions.

The damage mechanisms to which rollers may be subject are mostly wear and pitting, as well as adhesive failures (scuffing, scoring). Wear occurs when surfaces slide against each other and there is insufficient or no lubrication to keep the surfaces with micro-asperities separated. If a full hydrodynamic lubricant film can be maintained at all times, wear will not occur. In reality, however, this is very rarely the case and so wear is almost always unavoidable, especially under start-stop conditions.

Pitting is a fatigue phenomenon. As the loaded rolling element passes over a given point on a race, a subsurface stress field is generated. As the maximum subsurface shear stress is applied over and over again, eventually a fatigue crack is initiated and grows. When a series of these cracks reach the surface and join, a small spall is liberated by leaving a pit, and the bearing is said to be pitted.

Flow of electric current through the area of rolling contact also may affect the durability of rolling elements. Recently, a number of devices with rolling bearings operating under conditions that cause generation of induction currents in the rolling contact area has significantly increased. Examples are electrified powertrains/drivetrains or wind turbines. Electrical discharges (arcing) in a bearing occur in the area of contact of the rolling elements with the inner or outer rings. The passage of electric currents increases the temperature in the rolling contact area and sometimes damages the raceways by point melting of the surface of the rolling elements of the bearing and the appearance of craters at the places where the electric arc occurs in the lubricant film. This, in fact, leads to degradation of the surfaces on the rolling bodies. Electric arc discharges also have a negative impact on bearing lubrication and accelerate the aging of lubricants by oxidation.

Current passage favors the formation of so-called white etching cracks (WEC) by nascent hydrogen formed from oxidation of lubricants. Consequently, there is a need to generate WECs in a controlled manner in a test device and to elaborate the countermeasures.

Electric motors used in modern drive systems are often fed by frequency converters that can cause generation of high-frequency bearing currents, classified as electric discharge machining (EDM) or circular bearing current.

Overall, in electrified powertrains, DC and AC co-exist as well as inverter induced bearing currents. The different lubrication regimes can be characterized as follows:
a. Boundary lubrication: ohmic, current flows though the micro-asperities
b. Mixed lubrication: ohmic and capacitive,
c. Hydrodynamic lubrication: capacitive, current flows through separating film insulating the micro-asperities.

These regimes are related to the electrical properties of tribofilms and/or to bulk properties of fluids. This necessitates in relation to tribocontacts to measure, along with friction and wear, such parameters as relative permittivity (εr), electrical contact resistance (DC), Impedance Z (AC, as function of frequency), dielectric dissipation factor (tan δ) and phase shift Θ.

Testers for testing materials and rolling elements such as rollers used, e.g., in roller bearings are known in the art.

The German Patent Application Publication DE102004051186A1 published on Apr. 27, 2006 (inventor: Joachim Hering) discloses a device that includes a substitute bearing with an inner race and an outer race, between which rolling bodies are held in respective cage pockets of a retainer. The rolling bodies consist of a non-electrically-conductive material, or are coated with a non-electrically-conductive material. A measuring device is arranged within the substitute bearing so as to electrically connect the inner and outer races. The device also includes a unit for measuring current passing through the roller bearing.

Phoenix Tribology Ltd. (Phoenix USA) produces a TE 74 Two-Roller Test Machine that has two motors, one to provide the input power and one to absorb the transmitted power. To achieve the high loads with small diameter rollers, hence high contact pressures, the test rollers are mounted on shafts with bearings on either side, in the “fully supported” configuration. Consequently, spindle bearings are exposed to, and must run in, the test lubricant. The upper roller housing is electrically insulated, and the roller shaft is provided with a slip ring for measuring resistance of electrical contacts. A lubricant service module is fitted as standard incorporating a sump tank with an immersion heater, delivery pump, scavenge pump and oil to water heat exchangers for cooling.

Optimol Instruments GmbH, Munich, markets a twin disk tribometer (2 disk) for tribological evaluation of the slip-rolling and sliding behavior of rotating surfaces, in which one shaft is electrically insulated in order to measure the thickness of the lubricant film between the two test disks. This is a low-current measuring system that is not intended to investigate the influence of voltage and high currents on the slip-rolling fatigue resistance of materials.

### SUMMARY

The apparatus of the present invention is a testing machine for electrotribological testing of roller specimens (rollers) of various shapes, sizes and materials, either as bulk materials or coated materials, for testing resistance to wear, scoring, fatigue (pitting), with linear or elliptical (point) contacts in a wide range of test conditions such as working with lubricants, without lubrication, with rolling or slip-rolling or sliding of the contacting surfaces, with varying roller pressing forces, with regulation and measurement of the electrical voltage and current flowing through the roller contact area, etc.

More specifically, the universal apparatus for electrotribological testing of rolling specimens contains a mounting plate that supports a first drive motor, a second drive motor, a tray that can be filled with a lubricating substance for lubricating roller specimens, a first shaft for supporting a first rolling specimen, and a second shaft for supporting a second rolling specimen in contact with the first rolling specimen. The first shaft is driven by the first drive motor, and the second shaft is driven by the second drive motor independently from the first drive motor. At least one of the shafts, e.g., the second shaft, consists of a first portion that is located on the side of the second motor and a second portion that is located on the side of the second rolling specimen. The first portion and the second portion of the second shaft are interconnected via a constant-velocity joint (e.g., a cardan or CVT-type) that allows displacement of the second portion of the second shaft at least in a plane-parallel direction with respect to the first portion of the second shaft without changing the speed of rotation of the first portion and the second portion of the second shaft. This allows alignment of rolling bodies of different sample sizes and geometries.

According to another aspect of the invention, the first portion and the second portion of the second shaft are interconnected via a constant-velocity joint that allows displacement of the second portion of the second shaft in a plane-parallel direction and changing its angular position with respect to the first portion of the second shaft without changing the speed of rotation of the first portion and the second portion of the second shaft.

The apparatus further contains an electric system for passing and controlling an electric current between the first rolling specimen and the second rolling specimen. The electric system is completely self-contained and is electrically isolated from electroconductive components other than those included in the electric system by electrical isolation components.

According to one or several aspects of the invention, the electrical isolation components are a first electrical isolation component that does not pass an electric current and is installed in the first shaft, and a second electrical isolation component that does not pass an electric current and is installed in the second shaft so that, when an electric current is passed and controlled between the first rolling specimen and the second rolling specimen, sections of the first shaft and of the second shaft between the first electrical isolation component and the second electrical isolation component form an electrically isolates section, which is electrically isolated from portion of the first shaft and portion of the second shaft that are beyond the electrically isolates section.

### DRAWINGS

FIG. 1 is a schematic view of an apparatus of the invention according to an embodiment illustrating operation positions of two cylindrical rollers in a system with one double-cardan joint in one of roller-supporting shafts.

FIG. 2 is the electric current application and measurement system used in the apparatus of the invention.

FIG. 3 is a schematic view of an apparatus of the invention, which is similar to the apparatus of FIG. 1, with the exception that both drive shafts are equipped with the double-cardan joints.

FIG. 4 is a three-dimensional view of an exemplary mechanism that may be used for moving a first rolling specimen in a plane-parallel and angular directions.

FIG. 5A is a schematic view of an apparatus of the invention according to an embodiment illustrating testing of a barrel-shaped rolling specimen at angular positions of one of the specimen-supporting shafts.

FIG. 5B is a schematic view of the apparatus similar to one shown in FIG. 5A illustrating testing of tapered rolling specimens at an angular position of one of the rolling specimens supporting shafts with respect to the other.

FIG. 6 is a three-dimensional view of a constant-velocity joint that interconnects two portions of the drive shaft and operates on a principle of rolling the surface of a spherical body with a group of balls that roll along the groove on the surface of the spherical body.

FIG. 7 is an example of an axial displacement compensator that interconnects two sections of the shaft portion moveable with respect to each other without violation of transmission of the rotation.

FIG. 8 is a view of the apparatus similar to FIG. 5A but using a double-cardan joint instead of the constant-velocity joint shown in FIG. 6.

FIG. 9 is a view of the apparatus similar to one shown in FIG. 8 with the exception that moveable portions of both shafts are interconnected through double-cardan joints.

### DETAILED DESCRIPTION OF PREFERRED EMBODIMENTS OF THE INVENTION

The universal apparatus of the invention for electrotribological testing of rolling specimens (hereinafter referred to as the apparatus of the invention or merely as the apparatus) is intended for electrotribological testing of surfaces of rolling specimens such as, e.g. rollers, of various shapes and dimensions made from various materials. In the context of the present patent application the term “disk” is considered as a synonym to “roller”. The test objects are electrotribologically tested under various working conditions such as operation with various lubrication regimes, slip-ratios, different temperatures, various contact forces, and/or under conditions of passing electric current through the roller contact area. The apparatus makes it possible to create conditions for pure rolling or slip-rolling or sliding between the rolling specimens.

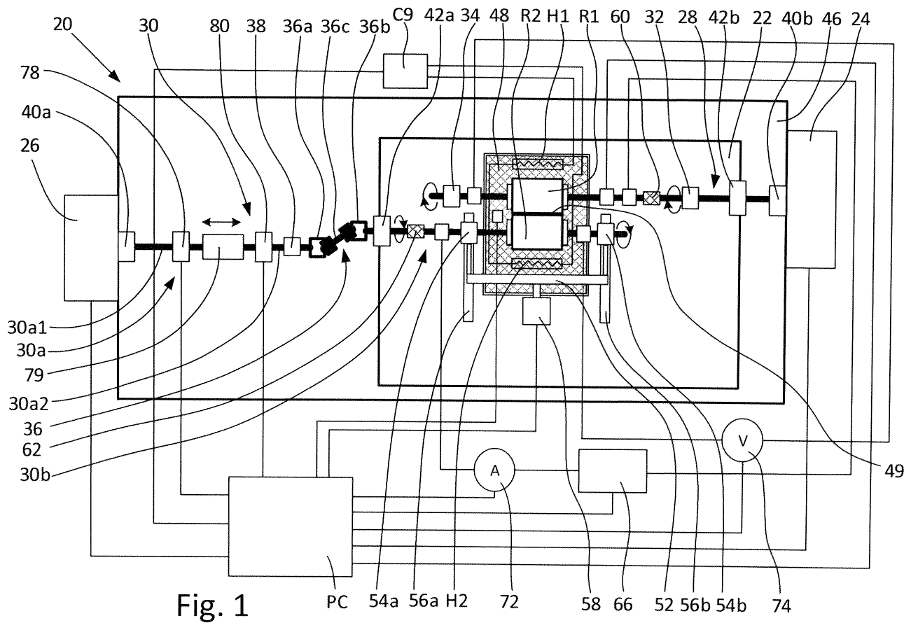

FIG. 1 is a schematic view of an apparatus of the invention according to an embodiment illustrating operation positions of two cylindrical rollers in a system with double-cardan joint in one of roller-supporting shafts.

As shown in FIG. 1, an apparatus 20 has a mounting plate 46 that supports a first drive motor 24 that is located on one side of the mounting plate 46 and a second drive motor 26 located on the other side of the mounting plate 46. Reference 22 designates a support plate. The apparatus 20 has a first shaft 28, one end of which is connected to an output shaft of the first drive motor 24 and the other end supports a first rolling specimen such as a test roller R1, and a second shaft 30, one end of which is connected to an output shaft of the second drive motor 26 and the other end supports a second rolling specimen such as a test roller R2. During the test both rollers are maintained in rolling contact under pressure, which is applied from a pressure application unit that will be described later.

In FIG. 1, reference numeral 32 designates a first-roller support that supports the first roller R1 on the side of the first drive motor 24, and reference numeral 34 designates a second-roller support located on the side of the first test roller R1 opposite to the first-roller support 32.

In the modification of the apparatus of FIG. 1, the second shaft 30 consists of a first shaft portion 30a and a second shaft portion 30b, which are interconnected through a double-cardan shaft 36 in a non-coaxial position with respect to each other. A double-cardan shaft is a device that consists of two universal joints interconnected through an intermediate shaft. In other words, the double-cardan shaft 36 consists of a first cardan 36a and a second cardan 36b, mounted back-to-back and interconnected through an intermediate shaft 36c. When the angle between the first portion 30a of the second shaft 30 and the intermediate shaft 36c is the same as the angle between the intermediate shaft 36c and the second portion 30b of the second shaft 30, the second universal joint 36b will have the same angular velocity as the first universal joint 36a. Reference numerals 38 and 40a designate bearing supports of the first portion 30a of the second shaft 30.

Reference numerals 40b and 42b designate bearing supports of the first shaft 28 on the side of the first drive motor 24.

The housing (not shown) supports a mounting plate 46 that supports an oil tray 48 that may be filled with a lubricating media needed for testing the effect of lubricant on the endurance of the test rollers operating under various contact pressures, speeds of rotation, electric currents in the roller contact area 49, etc.

In the modification of the apparatus shown in FIG. 1, the bearing supports 32, 34 and the tray 48 filled with a lubricating substance, e.g., oil (hereinafter sometimes referred to as an oil tray 48) are installed on the mounting plate 46. It is understood that the rollers can be lubricated by immersing roller peripheries into the lubricating oil or by supplying a lubricant directly into the roller-contact area 49, e.g., by dripping, spraying, etc. The lubricant may be liquid, grease-like, or powdered, depending on the prescribed test conditions.

According to one or several aspects of the invention, a pressure application unit 58 of the apparatus 20 consists of a carriage 52 that is slidingly installed on guides 56a and 56b and is rigidly connected to the second-roller supports 54a and 54b. Thus, the second roller R2 and the second-roller supports 54a and 54b are rigidly connected to the carriage 52 and can be integrally shifted together with the second test roller R2 in the direction perpendicular to the first shaft 28.

In the modification of FIG. 1, a pressure application unit 58 for applying pressure from the second roller R2 to the first roller R1 may be exemplified by a stepper motor. An example of a stepper motor suitable for the purposes of the invention is PK564AW by Oriental Motors, Inc.

An important and distinguishing feature of the apparatus 20 of the invention is an electric current application and measurement system 64 (hereinafter referred to as an electric system), which is capable of applying an electric current into the rolling contact area 49 and measuring the applied current and voltage.

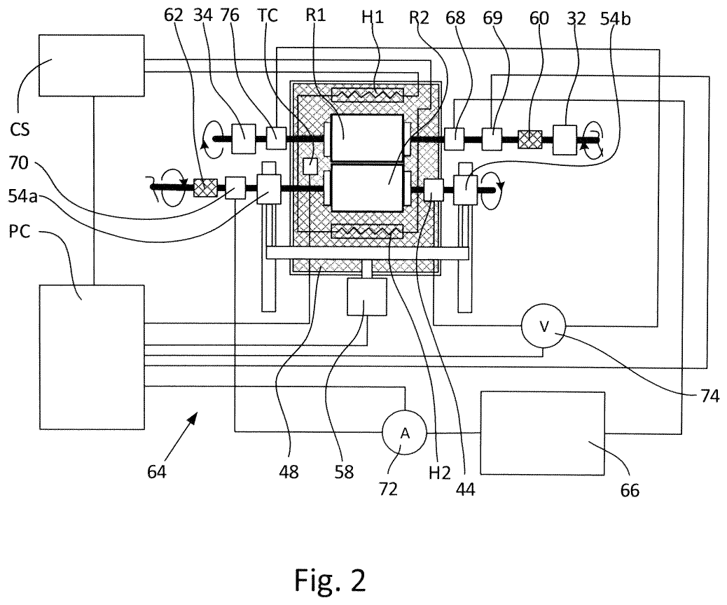

The electric system 64 is shown separately in FIG. 2 where components identical to those shown in FIG. 1 are designated by the same reference numerals.

In order to provide the second roller R2 with the possibility of release from the drive motor 26 (FIG. 1), apparatus 20 is equipped with an electrically controlled clutch 78 (FIG. 1) installed on the first part 30a of the second shaft 30. When test conditions require disconnection of the second rolling specimen R2 from positive drive, the clutch 78 may disconnect the second rolling specimen from the drive motor 26 and allow free rotation of this specimen. Reference numeral 80 designates a rotation speed meter.

In order to perform electric measurements of a current that passes through the contact area 49 between the test rolling specimens R1 and R2, it is necessary to form a complete measurement electric circuit that includes the rolling contact area 49 and that is electrically isolated from the external influences. For this purpose, the first shaft 28 and the second shaft 30 have electrically nonconductive parts. In the case of the first shaft 28, this is the first electrically nonconductive shaft part 60 located between the first roller R1 and the first drive motor 24. In the case of the second shaft 30, this is a second electrically nonconductive shaft part 62 located in the second portion 30b of the second shaft 30 between the second test roller R2 and the second drive motor 26. In other words, considering that the mounting plate 46 (FIG. 1) can be made from a dielectric material and due to the provision of the aforementioned electrically nonconductive shaft parts, the rollers may be completely electrically isolated from the external electric current effects except for a current source 66 of the current application and measurement system 64 (FIG. 2). The current source 66 may be of a direct current source (DC) or an alternating current source (AC). In the ca se of AC, the oscillation frequency should be in the range from several Hz to several MHz.

The electrically nonconductive part may be comprised of the intermediate shaft 36c.

Reference numerals 68 and 70 are current collectors (FIG. 2). The electric current flows from the current source 66 to the first test roller R1 via the current collector 68, passes to the second test roller R2 through the roller contact area 49, and completes the circuit by returning to the current source 66 via the current collector 70. A current meter 72 and a voltage meter 74 are also included into the electric circuit for measuring the current and voltage during the test. An example of current collectors suitable for the purposes of the invention are slip rings of Moflon Company, type: GHS2586. Another pair of similar current collectors 76 and 44 can be used separately for independent measurement of voltage.

The apparatus 20 is also provided with a standard thermocouple 76 for controlling the temperature of the lubricant and with electric heaters H1 and H2. The heating electric circuit that passes the electric current through the heaters H1 and H2 is supplied from the electric power source CS.

As can be seen from FIG. 2, electric current application and measurement system 64 includes a computer PC, which controls all electrically operated components, devices and instruments such as the first drive motor 24, second drive motor 26, power source 66, electric current source CS, electric heaters H1 and H2, electrically controlled clutch 78, rotation speed meter 80, thermocouple TC, pressure-application unit 58, electric current meter 72, electric voltage meter 74, current collectors 68, 70, 44, 76, etc.

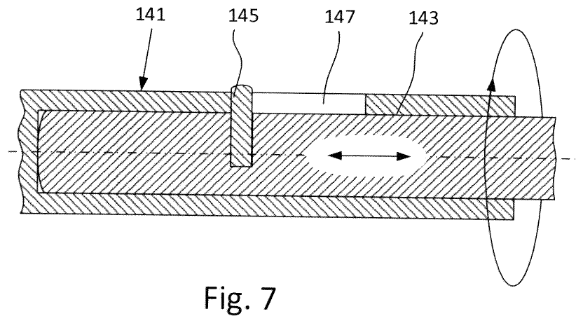

As shown in FIG. 1, the first portion 30a of the second shaft 30 also consists of two sections 30a1 and 30a2, one of which can be axially displaced with respect to the other without violation of the rotation transmission function. For this purpose, the first portion 30a of the second shaft 30 is provided with a linear extension compensator 79, e.g., of a telescopic-sleeve type. The aforementioned linear displacements are caused by axial displacements of the universal joint 36a of the double-cardan shaft 36. The structure of this device is schematically shown in FIG. 7.

The apparatus 20 shown schematically in FIG. 1 illustrated an embodiment of a universal roller-testing machine with only one double-cardan shaft 36. The use of a single double-cardan shaft is sufficient for testing rollers of relatively small and equal diameters. However, when one or both test rollers have a significant diameter and thus it is necessary to increase the interaxial distance between the shafts, it would be advantageous to provide the apparatus of the invention with the double-cardan shafts installed on both roller-supporting shafts.

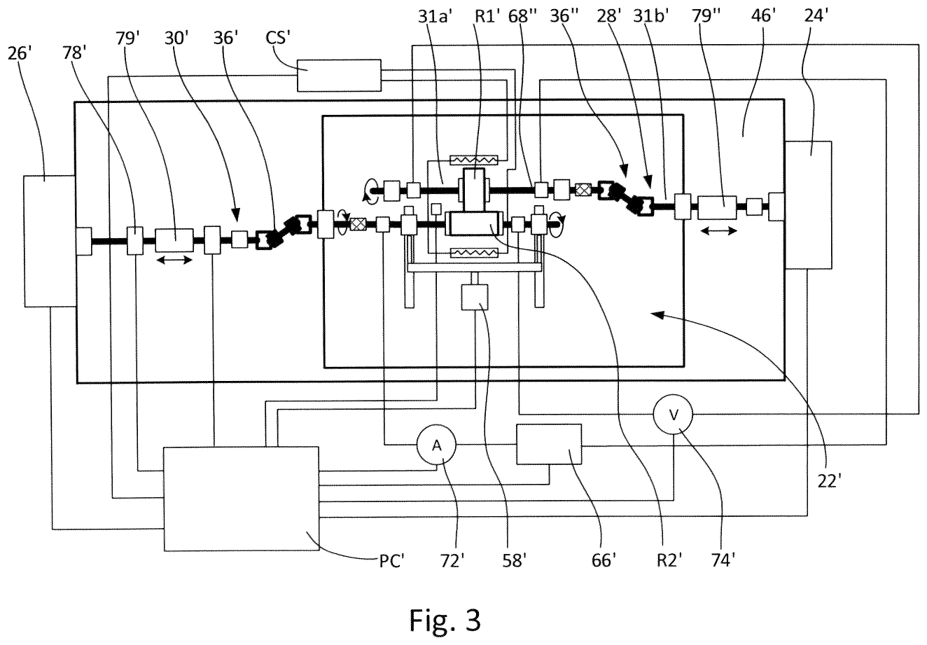

Since many of the parts and units of apparatus 20′ shown in FIG. 3 are identical to those used in the apparatus 20 of FIG. 1, their detailed description is omitted, and they are designated by the same reference numerals with an addition of a prime or two primes. For example, in FIG. 3 the first shaft is designated by reference numeral 28′, the second shaft is designated by reference numeral 30′, the double-cardan shaft of the first shaft is designated by reference numeral 36″, the double-cardan shaft of the second shaft is designated by reference numeral 36′, etc.

In the embodiment of FIG. 3, just for the sake of an example only, the first test roller R1′ is shown with a diameter greater than diameter of the second test roller R2′. However, the second roller R2′ is wider than the first roller R1′.

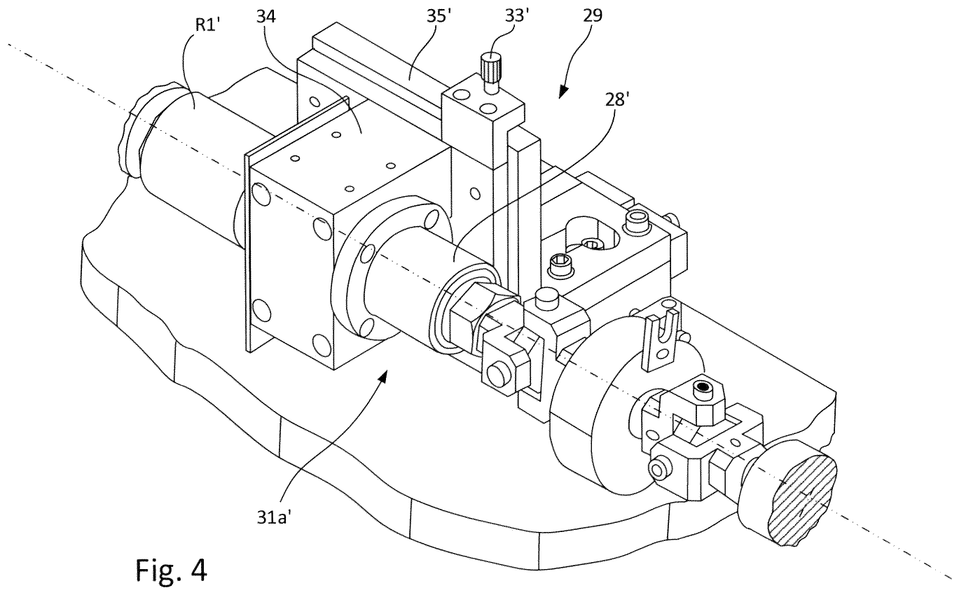

To accommodate test rollers of various shapes and diameters, the apparatus 20′ is provided with a support-adjustment unit 29 of the type shown in FIG. 4 (not shown in FIG. 3), which is installed on the mounting plate 46 (FIG. 1). The adjustment operation is performed by rotating the head of the screw 33′ the end of which is rests on a support surface 35′, which is integral with the first-roller support 32 (FIG. 1). It is understood that the aforementioned relative motion is possible due to the provision of the double-cardan shaft 36″ that interconnects shaft portions 31a′ and 31b′ (FIG. 3) in combination with the second linear extension compensator 79″ identical with the linear extension compensator 79′ between the sections of the shaft 30′, and of the sections 30a1 and 30a2 of the apparatus 20 shown in FIG. 1.

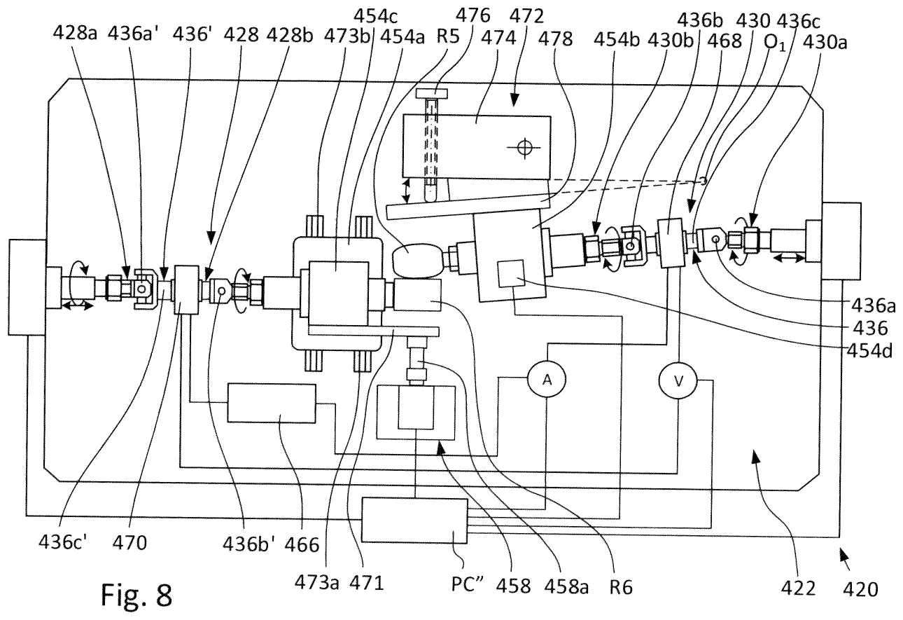

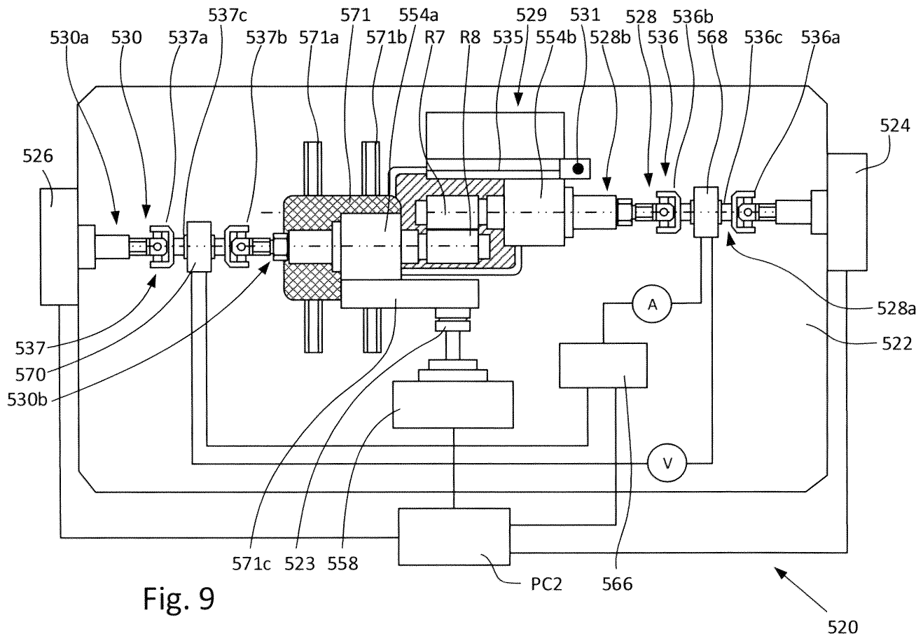

As understood with reference to the modifications shown in FIGS. 8 and 9, which are described later, the support adjustment unit 29 can be used for adjusting a position of the first roller support 454b with the associated first roller specimen R5 or for adjusting position of the second roller support 454c with associated second roller specimen R6 in a vertical, horizontal, and an angular direction thus changing positions of one roller specimen relative to the opposite roller specimen.

In the modification of FIG. 3, the portion 31b′ of the first shaft 28′ is also provided with a linear extension compensator 79″. Such a second compensator is needed because of the provision of the second double-cardan shaft 36″. The axial displacement compensator 79″ may have the same structure as the linear extension compensator 79 (FIG. 1 and FIG. 7) and the linear extension compensator 79′ (FIGS. 3 and 7).

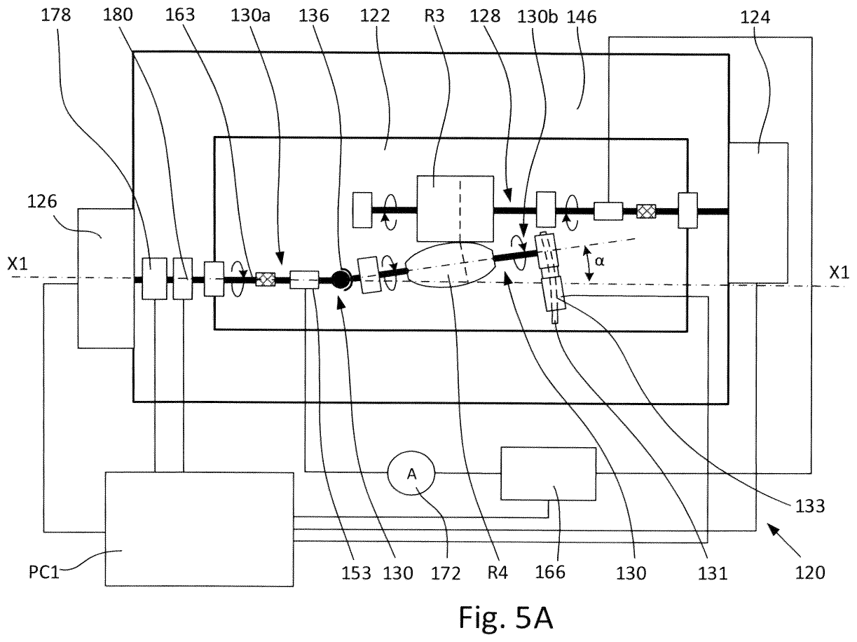

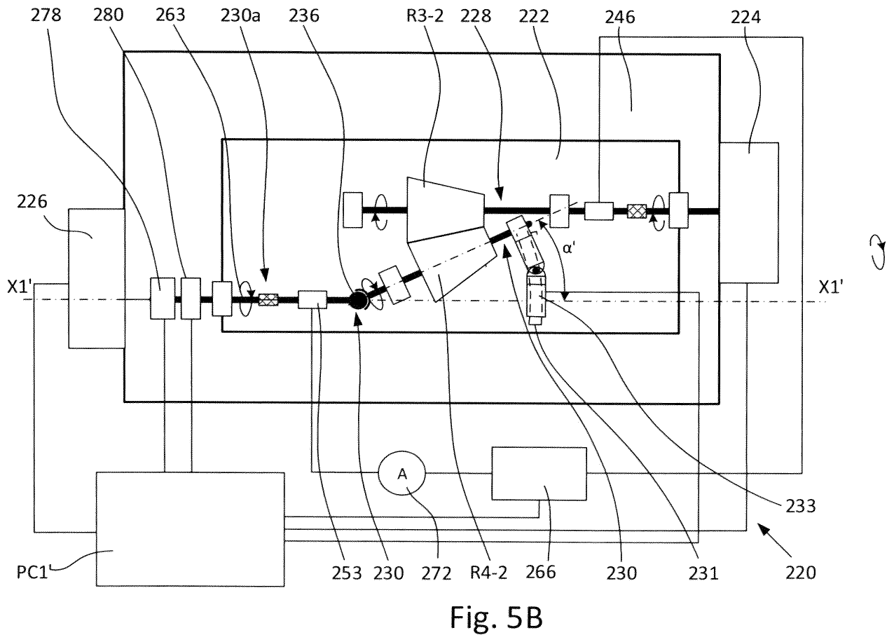

FIG. 5A is another embodiment of the apparatus of the invention. Since many parts, devices and units of the apparatus 120 of FIG. 5A are identical to those of the apparatus of the previous modifications shown in FIGS. 1 and 3, they will be designated by the same reference numerals but with an addition of 100 and their detailed description will be omitted. For example, in FIG. 5A the first drive motor is designated by reference numeral 124, the second drive motor is designated by reference numeral 126, the electrically controlled clutch 78 is designated by reference numeral 178, etc.

Some details of the electric system of the apparatus of FIG. 5A are not shown and omitted from the description in view of their similarity with the same components of FIGS. 1 and 3. In the embodiment of FIG. 5A, the computer is designated by the symbol PC1.

The apparatus of FIG. 5A uses a constant-velocity spherical-body type universal joint 136 of a type different from the double-cardan shaft 36 (FIG. 1). The constant-velocity joint 136 allows for a non-coaxial position of both shafts. In fact, the second portion 130b of the second shaft 130 can be angularly displaced within a certain range (angle α) with respect to the longitudinal axis X1-X1 of the first shaft 128 and a first portion 130a of the second shaft 130 (without a noticeable increase in friction or backlash) and while maintaining the same velocity. The pressure-application unit for pressing the barrel-shaped rolling specimen R4 to the cylindrical rolling specimen R3 is not shown in FIG. 5A as it is the same as the pressure-application units 58 (FIGS. 1) and 58′ (FIG. 3).

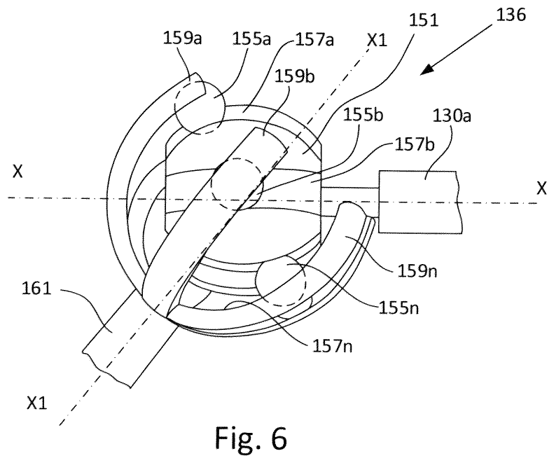

In fact, the constant-velocity joints 136 may be of different types known in the art under such names as Tracta joints, Rzeppa joints, Bitfield joints, etc. The structure of the constant-velocity joint is shown only as an example in FIG. 6.

The apparatus modification shown in FIG. 5A allows testing, e.g., of barrel rollers used, e.g., in barrel roller bearings, which are characterized by self-aligning properties. In the modification of FIG. 5A, the first test roller R3 is a cylindrical roller, and the second rolling specimen R4 is a barrel roller. However, other combinations are possible.

In order to provide angular displacement of the shaft part 130b with the barrel roller R4 with respect to the shaft part 130a, the apparatus 120 is equipped with an arcuate guide 131 attached to a plate 122 that is laid onto a base plate 146 and with an actuator 133 attached to the end of the roller-supporting shaft part 130b, which is guided on the arcuate guide 131.

FIG. 5B illustrates another embodiment of the apparatus of the invention. Since many parts, units and devices of the apparatus 220 of FIG. 5B are identical to those of the apparatus 120 of the previous modification shown in FIG. 5A, they will be designated by the same reference numerals but with an addition of 200 and their detailed description will be omitted. For example, in FIG. 5B the first drive motor is designated by reference numeral 224, the second drive motor is designated by reference numeral 226, the electrically controlled clutch 78 is designated by reference numeral 278, the computer is designated by symbol PC1′, etc.

Some details of the electric system of the apparatus of FIG. 5B are not shown and omitted from the description in view of their similarity with the same components of FIGS. 1 and 3. In the embodiment of FIG. 5B, the computer is designated by the symbol PC1′.

The apparatus of FIG. 5B uses a constant-velocity spherical-body type universal joint 236 of the same type as in the apparatus modification shown in FIG. 5A and described in more detail with reference to FIG. 6. As in FIG. 5A, the second portion 230b of the second shaft 230 can be angularly displaced within a certain range (angle α′) with respect to the longitudinal axis X1′-X1′ of the first shaft 228 and a first portion 230a of the second shaft 230 (without a noticeable increase in friction or backlash) and while maintaining the same velocity.

In fact, the apparatus of modification shown in FIG. 5B is the same as one shown in FIG. 5A but illustrated in connection with the electrotribological testing of tapered rolling specimens R3-2 and R4-2, wherein the tapered rolling specimen R3-2 is supported by the first shaft 228 and the second rolling specimen is supported by the second portion 230b of the second shaft 230.

In order to prevent the tapered rolling specimens from runouts, they are arranged so that in each point of rolling contact the tapered rolling specimens R3-2 and R4-2 have the same radii.

FIGS. 1, 2, 3, 5A and 5B illustrate the main principle structural features of preferred modification of the apparatus of the invention. Given below are more detailed descriptions of some essential parts and units of the apparatuses 20 and 120.

FIG. 6 illustrates an arrangement of the constant-velocity joint 136. This device operates on a principle of rolling the surface of a spherical body 151 with a group of balls 155a, 155b, . . . 155n (only three balls are shown for simplicity). During rotation of the spherical body 151, the balls 155a, 155b, . . . 155n roll along grooves 157a, 157b . . . 157n formed on the periphery of the spherical body 151 in such a way that the longitudinal section planes of the grooves pass through the axis X-X of rotation of the spherical body 151, and hence of an angularly mobile portion second part 130b (i.e., the second shaft 130 (FIG. 3)), with which the spherical body 151 is rigidly connected.

The balls 155a, 155b, . . . 155n are held in place by respective fingers 159a, 159b . . . 159n, the ball-contacting surfaces of which are arranged on an imaginary sphere that concentrically embraces the spherical body 151. The fingertips form a yoke 161, which is rigidly connected to the shaft 130b (FIG. 5A).

FIG. 7 is a sectional longitudinal view of the linear extension compensator 79, which may consist of a telescopic tube 141, which is an axially immobile integral portion of the first part 30a of the shaft 30 (FIG. 1). The telescopic tube 141 slidingly receives an axially moveable portion 143, which is rigidly connected to the cardan universal unit 36a. In order to prevent rotary displacement of the axially moveable portion 143 relative to the telescopic tube 141, the axially moveable portion 143 has a pin 145 that slides in an axial peripheral slot 147 formed in the telescopic tube 141.

Having described various embodiments of the apparatus of the invention, let us consider operations of these embodiments with emphasis on the versatility. The versatility of the apparatus of the invention results from the fact that the roller supporting shafts can be arranged parallel to each other or at a selected angle to each other thus making it possible to test rolling specimens of various shapes such as cylindrical, barrel-shaped, tapered, etc. The apparatus allows selection of rolling specimens of various diameters and allows for adjustment of the distance between the first roller supporting shaft and the second roller supporting shaft.

The apparatus provides testing under various operation conditions such as test with rolling or sliding or slide-rolling, with lubrication, and with passage of the electric current through the contact area.

In the case of the apparatus 20 shown in FIG. 1, the test rolling specimens are cylindrical rollers R1 and R2 of equal or different diameters. If it is necessary to provide pure rolling without any sliding between the roller peripheries, this is achieved by adjusting the rotations speeds of the rollers on output shafts of drive motors 24 and 26, which work independently. If it is necessary to test the roller R1 and R2 for resistance to fatigue pitting, the lower edges of the rollers may be immersed into a selected lubricating oil in the tray. The lubricant may be added to the contact area by spraying, fogging, etc. If it is necessary to test the rollers for resistance to scoring, they may be rotated with different linear velocities in the contact area and with or without supply of the lubricant. For revealing the effect of electric current on the working conditions and endurance of the rollers of various materials operating under lubrication or dry conditions, an electric current is passed through the roller-to-roller contact area. This is achieved by passing the electric current from the current source 66 (FIGS. 1 and 2) to the first test roller R1 via the current collector 68, to the second test roller R2 through the roller contact area 49, and completing the circuit by returning the current to the current source 66 via the current collector 70. The test current and voltage are measured by the current meter 72 and a voltage meter 74 respectively. The force with which the roller R2 is pressed to roller R1 is provided by the pressure-application unit 58. All actions are performed under the control of the computer PC that regulates the contact pressure, supply of electric current, temperature in the lubricating oil, etc.

Since the rotation is transmitted from the first section 30a1 of the second shaft 30 to the second section 30a2 that performs axial displacements relative to the first section, these displacements are compensated for by the provision of the linear extension compensator 79, the structure of which is exemplified by the mechanism shown in FIG. 7.

A torque meter 69 is shown in FIG. 2 installed in the first portion of the first shaft. In fact, torque meters may be installed in both shafts as the shafts are driven from independent motors. An example of a torque meter suitable for the invention is torque sensors mod. TRS300 or TRS600 of Futek, Inc.

The structure of the apparatus 20′ in FIG. 3 is identical to the apparatus 20 of FIG. 1, except that rotation to the first rolling specimen R1′ from the first drive motor 24′ also is transmitted through a double-cardan shaft 36″, e.g., of the same type as the double-cardan shaft 36′ installed in the second shaft 30′. Therefore, the second linear extension compensator 79″ also is needed for the connection of the second section to the first section of the first portion of the first shaft 28′.

Constant-velocity joints that connect the first portion 30a of the second shaft 30 and the second portion 30b of the second shafts 30 shown in FIG. 1 and the respective portions of the shafts shown in FIG. 3 are double-cardan shafts.

A configuration known as a double-cardan shaft uses two cardan joints facing opposite directions and interconnected via an intermediate shaft. In order to function as a constant-velocity unit, the second cardan joint should be phased in relation to the first cardan joint for canceling the change in angular velocity. In the double-cardan shaft unit, the angular velocity of the driven shaft will match that of the driving shaft when the driving shaft and the driven shaft are arranged at equal angles with respect to the intermediate shaft and when the two universal cardan joints are out of phase by 90 degrees. The doble-cardan shaft unit allows plane-parallel displacement of the driven shaft portion 30b relative to the driving shaft portion 30a (FIG. 1).

In the embodiment of FIG. 5A, one section of one of the roller-supporting shafts, e.g., the second section 130b of the second shaft 130, is arranged at a certain angle α relative to the longitudinal axis X1-X1 of the first portion 130a of the second shaft 130. In FIG. 5A, the barrel-shaped roller R4 has a point rolling contact with the cylindrical rolling specimen R3. The rolling speeds, location of the contact point, the applied contact force, lubrication conditions, measurement parameters, etc., are adjustable and controlled by the computer PC1.

FIG. 8 illustrates another embodiment of the invention made in accordance with one or several aspects of the present invention. The universal tester of FIG. 8 is similar to that of FIG. 3 in that the shaft portions are also interconnected through double-cardan shafts. Some parts and components similar to those of FIG. 3 and to designations used for other modifications of the tester are designated by the same reference numerals but start from 400. Thus, the universal tester is designated by reference numeral 420, the base plate is designated by reference numeral 422, the computer is designated by symbol PC″, etc.

In other words, the universal tester of FIG. 8 contains the base plate 422 that may be made from an electrically conductive or electrically nonconductive material or may be covered with an electrically nonconductive plate (not shown) and that supports a roller support 454b that supports the first roller R5 on the second portion 430b of the first shaft 430 and a roller support 454c that supports the second roller R6 on the second portion 428b of the second shaft 428.

In the modification of FIG. 8, the first portion 430a and the second portion 430b of the first roller supporting shaft 430 are interconnected via a double-cardan shaft 436. The first portion 428a and the second portion 428b of the second roller supporting shaft 428 are interconnected via a double-cardan shaft 436′. The double-cardan shaft 436 consists of a first cardan 436a, a second cardan 436b, and an intermediate shaft 436c that interconnects the first cardan 436a and the second cardan 436b and supports the first current collector 468.

The double-cardan shaft 436′ of the apparatus of FIG. 8 consists of a first cardan 436a′, a second cardan 436b′, and an intermediate shaft 436c′ that interconnects the first cardan 436a′ and the second cardan 436b′ and supports the second current collector 470.

In the modification of FIG. 8, the pressure-application unit 458 is installed on a base plate 422 and consists of a pressure-application unit 458 that has a pressure-application tip 458a arranged perpendicular to a pressure-receiving plate 471 attached to the second roller support 454c that is installed on a sliding plate 454a. The latter is slidingly installed on guides 473a and 473b. The sliding plate can be made from an electrically nonconductive material.

The computer PC″ is connected to all electrically controlled components of the electric system such as an electric current source 466, etc. The first current collector 468 and the second current collector 470 that belong to the electric system of the apparatus of FIG. 8 are installed on the intermediate shafts 436c and 436′, respectively.

In FIG. 8, reference numeral 472 designates a mechanism for adjusting an angle between the first portion 430a and the second portion 430b of the first roller supporting shaft 430. The mechanism 472 consists of a block 474 that is attached to the base plate 422 and a screw 476 threaded into the block 474. The end of the screw 476 rests against a plate 478, which is attached to the first roller support 454b. Screwing the screw into the block 474 rotates the support 454b and thus the part 430b around the axis O₁ and relative to the part 430a.

According to one or several aspects of the invention, the apparatus 420 can be provided with an acoustic emission (AE) sensor 454d, which can also function as a vibration detector (FIG. 8). An example of such a device is a 9208-20-1000 kHz Miniature High Fidelity Displacement AE Sensor of Physical Acoustics (USA). S9208 is a high-fidelity displacement sensor. It is specially designed to provide a flat frequency response to surface acoustic displacement over its entire frequency bandwidth. It is primarily designed for research applications for studying the surface displacement of structures due to different AE modes. It can be used in applications requiring frequency analysis to characterize different kinds of defects. The output of the acoustic emission sensor is connected to the computer PC″ for receiving and processing the output data obtained from the sensor 454d. In the embodiment shown in FIG. 8, the acoustic emission sensor 454d is installed on the first roller support 454b, although it can be installed on the second roller support or on any other part of the apparatus 420 sensitive to the vibrations.

FIG. 9 is a view of the apparatus, which is similar to FIG. 8 with the exception that both rollers are similar in shape (i.e., both cylindrical or both barrel shaped). Similar parts and components of the apparatus of FIG. 9 will be designated by the same reference numerals as in FIG. 8 but with an addition of 500.

The apparatus of FIG. 9, which in general is designated by reference numeral 520, has a mounting plate 522 that supports a first drive motor 524 that rotationally drives a first specimen supporting shaft 528 with a first roller R7 supported by a roller-support 554b and a second drive motor 526 that rotationally drives a second specimen supporting shaft 530 with a second roller R8 rotationally supported by the second roller support 554a.

The first shaft 528 consists of a first shaft portion 528a that is connected to the first drive motor 524 and a second portion 528b that is supported by the first-roller support 554b and that has an end projecting from the roller support for supporting a first rolling specimen, e.g., a cylindrical roller R7. The first portion 528a and the second portion 528b of the first specimen support shaft 528 are interconnected through a first double-cardan shaft 536 that consists of a first cardan 536a and a second cardan 536b. The first cardan 536a and the second cardan 536b of the first cardan shaft 536 are interconnected through an intermediate shaft 536c.

The second shaft 530 consists of a first shaft portion 530a that is connected to the second drive motor 526 and a second portion 530b that is supported by the second roller support 554a and that has an end projecting from the second roller support 554b for supporting a second rolling specimen, e.g., a cylindrical roller R8. The first shaft portion 530a and the second shaft portion 530b of the second shaft 530 are interconnected through a second double-cardan shaft 537 that consists of a first cardan 537a and a second cardan 537b. The first cardan 537a and the second cardan 537b of the second cardan shaft 537 are interconnected through an intermediate shaft 537c.

In the modification of FIG. 9, the pressure-application unit 558 is installed on the mounting plate 522 and has a pusher 523 that is pressed against a pressure-receiving plate 571c that can be made from an electrically nonconductive material. The pressure-receiving component 571c is rigidly connected with the second-roller support 554a, which, in turn, is installed on a plate 571 that can be made, e.g., from an electrically nonconductive material. In order to compensate for movements of the roller support 554a caused by the action of the pressure-application unit 558 and by the turn of the second portion 530b of the second shaft 530, the electrically nonconductive plate 571 is slidingly installed on guides 571a and 571b. +

The electric system of the tester of FIG. 9 is the same as the electric system of previously described modification and therefore only some elements of the electric system are shown in the drawing. Symbol PC2 designates a computer that is connected to all electrically controlled components of the electric system such as an electric current source 566, etc. A first current collector 568 and a second current collector 570, that belong to the electric system of the apparatus of FIG. 9 are installed on the first and the second intermediate shafts 536c and 537c, respectively.

Reference numeral 529 designates a support adjustment unit, which is similar to the unit 29 shown in FIG. 4. In FIG. 9, reference numeral 535 designates the support surface, which is similar to the surface 35 of the device shown in FIG. 4. The screw that is urged into the surface 535 is designated by reference numeral 531.

Thus, it has been shown that the apparatus of the present invention is a testing machine for electrotribological testing of roller specimens of various shapes, sizes and materials for testing resistance to wear, scoring, fatigue, pitting, with linear or point contacts in a wide range of test conditions such as working with lubricants, without lubrication, with rolling or slip-rolling or sliding of the contacting surfaces, with varying roller pressing forces, with regulation and measurement of the electrical voltage and current flowing through the roller contact area, etc.

Although the apparatus has been described with reference to specific drawings and descriptions, it is understood that these descriptions and drawings have been given by way of example only and that any modifications and variations are permitted within the scope of the appended patent claims. For example, constant-velocity joints other than the illustrated-cardan and balls-in-the spherical-body type devices can be used. Mechanical, hydraulic or pneumatic roller pressing mechanisms can be used as the pressure-application unit 58. A piezo-electric device can be used instead of the stepper motor can be used as the pressure-application unit 58. Linear extension compensators and roller support adjustment mechanisms also may have different structures.

Although it is not shown and not described herein, the apparatus of FIG. 5A may be provided with a mechanism for maintaining the pressure applied from the rolling specimen R4 to the rolling specimen R3 at a constant value by adjusting the value of angle α as the roller R4 wears out.

1. A universal apparatus for electrotribological testing of rolling specimens comprising:
a mounting plate that supports a first drive motor, a second drive motor, a first roller support for supporting a first rolling specimen on a first shaft, and a second roller support for supporting a second rolling specimen on a second shaft, the first shaft being driven by the first drive motor, and the second shaft being driven by the second drive motor independently from the first drive motor; at least one of the shafts comprising a first portion that is located on the side opposite to the rolling specimen installed on said at least one of the shafts and a second portion that is located on the side of the rolling specimen supported by said at least one of the shafts;
at least one joint that interconnects the first portion and the second portion of said at least one of the shafts, said at least one joint being selected from the group consisting of a double-cardan shaft and a constant-velocity joint;
a pressure-application unit having a pressure-application tip and a pressure-receiving plate installed on a roller support selected from the first roller support and the second roller support for interaction with the pressure-application tip and for bringing the first rolling specimen and the second rolling specimen into mutual contact;
an electric system for passing and controlling an electric current between the first rolling specimen and the second rolling specimen, the electric system being a self-contained electric system and comprising an electric circuit, which is electrically isolated by electrical isolation components from electroconductive components of the universal apparatus other than those included in the electric circuit of the electric system.

2. The universal apparatus according to claim 1, wherein the electrical isolation components are selected from the group consisting of a base plate made from an electrically nonconductive material, electrically nonconductive roller support parts, electrically nonconductive plates, electrically nonconductive shaft parts, or a combination thereof.

3. The universal apparatus according to claim 2, wherein the electrically nonconductive shaft parts comprise a first electrically nonconductive shaft part that is installed in the first shaft and a second electrically nonconductive shaft part that is installed in the second shaft so that, when an electric current is passed and controlled between the first rolling specimen and the second rolling specimen, the first electrically nonconductive shaft part of the first shaft and the second electrically nonconductive shaft part of the second shaft electrically isolate the electric circuit of the electric system from electrically conductive parts of the universal apparatus that are not included in the electric system.

4. The universal apparatus of claim 2, wherein the electric system further comprises:
a current source selected from the group consisting of a constant current source and an alternating current source, and at least one current collector that together with the first rolling specimen, the second rolling specimen, and the current source defines, during passing and controlling electric current, a complete measurement electric circuit, which is electrically isolated from parts of the universal apparatus that are not included in the complete measurement electric circuit.

5. The universal apparatus according to claim 4, wherein the double cardan shaft comprises a first cardan joint and a second cardan joint interconnected by an intermediate shaft and wherein said at least one current collector is installed on the intermediate shaft.

6. The universal apparatus according to claim 5, wherein the intermediate shaft is made from an electrically nonconductive material.

7. The universal apparatus of claim 1, wherein the roller support selected from the first roller support and the second roller support is installed on a sliding plate that is slidingly installed on linear guides for compensating motions of the roller support caused by the action of the pressure-application unit and of the said at least one joint.

8. The universal apparatus of claim 7, wherein the sliding plate is made from an electrically nonconductive material.

9. The universal apparatus of claim 1, wherein the pressure-application unit comprises a stepper motor.

10. The universal apparatus of claim 1, further comprising a support adjustment unit installed on the mounting plate for adjusting position of the roller support selected from the first roller support and the second roller support together with the second portion of the said at least one of the first shaft and the second shaft associated with said roller support selected from the first roller support and the second roller support in a vertical, a horizontal, and an angular direction for adjusting position of a rolling specimen associated with said roller support selected from the first roller support and the second roller support relative to the opposite rolling specimen.

11. The universal apparatus of claim 3, wherein said at least one of the shafts comprises a first portion that is located between the drive motor that drives said at least one of the shafts and the at least one joint, and a second portion that is located between the at least one joint and the rolling specimen supported by said at least one of the shafts, said first portion comprising a first section that is connected to the drive motor that drives said at least one of the shafts, a second section that is connected to the at least one joint and that is moveable relative to the first section, and a linear extension compensator that allows linear displacement of the second section relative to the first section to compensate for the displacement of the second section caused by the operation of said at least one joint.

12. The universal apparatus of claim 11, wherein the linear extension compensator comprises a first telescopic element integral with one of the first section or the second section and a second telescopic element slidingly interacting with the first telescopic element and integral with the other of the second section or the first section, the linear extension compensator having means that prevent turning of the first section and the second section relative to each other.

13. The universal apparatus of claim 1, further comprising: a tray filled with a lubricating substance that is located below said at least one of the rolling specimens, at least one electric heater for heating the lubricating substance, and a thermocouple for measuring temperature of the lubricating substance.

14. The universal apparatus of claim 3, further comprising: a tray filled with a lubricating substance that is located below said at least one of the rolling specimens, at least one electric heater for heating the lubricating substance, and a thermocouple for measuring temperature of the lubricating substance.

15. The universal apparatus of claim 14, wherein the electric system further comprises:
a current source selected from the group consisting of a constant current source and an alternating current source, and at least one current collector that together with the first rolling specimen, the second rolling specimen, and the current source defines, during passing and controlling electric current, a complete measurement electric circuit, which is electrically isolated from parts of the universal apparatus that are not included in the complete measurement electric circuit.

16. The universal apparatus of claim 3, wherein the electric system further comprises the first drive motor, the second drive motor, the current source, the at least one current collector, the at least one electric heater, the thermocouple, the electric voltage meter, the electric current meter, the pressure-application unit, and the electrically controlled clutch.

17. The universal apparatus of claim 4, wherein the electric system further comprises: an electric current meter and an electric voltage meter; and a computer that is electrically connected to the first drive motor, the second drive motor, the current source, the at least one current collector, the at least one electric heater, the thermocouple, the electric voltage meter, the electric current meter, the pressure-application unit, and the electrically controlled clutch.

18. The universal apparatus of claim 1, wherein said at least one of the shafts further comprises an electrically controlled clutch for kinematically disconnecting the drive motor that drives said at least one of the shafts.

19. The universal apparatus of claim 13, wherein the electric system further comprises: an electric current meter and an electric voltage meter; and a computer that is electrically connected to the first drive motor, the second drive motor, the current source, the at least one current collector, the at least one electric heater, the thermocouple, the electric voltage meter, the electric current meter, the pressure-application unit, and the electrically controlled clutch.

20. The universal apparatus of claim 15, further comprising a torque meter and a rotation speed meter installed on at least one of the shafts.

21. The universal apparatus of claim 17, further comprising an acoustic emission sensor installed on a roller support selected from the group comprising the first roller support and the second roller support, the acoustic emission sensor being connected to the computer.

22. A universal apparatus for electrotribological testing of rolling specimens comprising:
a mounting plate that supports a first drive motor, a second drive motor, a first roller support for supporting a first rolling specimen on a first shaft, and a second roller support for supporting a second rolling specimen on a second shaft, the first shaft being driven by the first drive motor, and the second shaft being driven by the second drive motor independently from the first drive motor; the first shaft comprising a first portion that is located on the side of the first shaft opposite to the first rolling specimen and a second portion that supports the first rolling specimen; the second shaft comprising a first portion that is located on the side of the second shaft opposite to the second rolling specimen and a second portion that supports the second rolling specimen;
a first joint that interconnects the first portion and the second portion of the first shaft and a second joint that interconnects the first portion and the second portion of the second shaft, each of said first joint and second joint being selected from the group consisting of a double-cardan shaft and a constant-velocity joint;
a pressure-application unit having a pressure-application tip and a pressure-receiving plate installed on a roller support selected from the first roller support and the second roller support for interaction with the pressure-application tip and for bringing a first rolling specimen and the second rolling specimen into mutual contact; and
an electric system for passing and controlling an electric current between the first rolling specimen and the second rolling specimen, the electric system being a self-contained electric system and comprising an electric circuit, which is electrically isolated by electrical isolation components from electroconductive components of the universal apparatus other than those included in the electric circuit of the electric system.

23. The universal apparatus of claim 21, further comprising a mechanism for adjusting an angle between the first portion and the second portion of the first shaft, the mechanism comprising a block that is attached to the base plate and a screw threaded into the block, wherein an end of the screw rests against a plate that is attached to the first roller support.
